(19) United States
(12) Patent Application Publication
(10) Pub. No.: US 2010/0051591 A1
(43) Pub. Date: Mar. 4, 2010

(54) OPERATION CONTROLLER AND CONTROL METHOD OF ELECTRODE IN ELECTRIC RESISTANCE WELDING

(76) Inventors: Yoshitaka Aoyama, Osaka (JP); Shoji Aoyama, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 12/595,272

(22) PCT Filed: Mar. 14, 2008
(86) PCT No.: PCT/JP2008/054737

§ 371 Date: Oct. 9, 2009

(30) Foreign Application Priority Data
Apr. 20, 2007 (JP) 2007-135993

(51) Int. Cl. B23K 11/00

(52) U.S. Cl. 219/117.1; 219/119

(57) ABSTRACT

Provided are an operation controller of an electrode and a control method therefor in electric resistance welding, which are capable of automatically inhibiting advancement of the electrode when an operating time period of a supply rod becomes abnormally longer. A part (1, 39) is supplied to the electrode by a supply rod (10), a steel plate part (4) is subjected to electric resistance welding, and there are provided a sensor means (27) which transmits an electrode advancing operation signal during restoring operation or at a time of completion of the restoring operation of the supply rod (10), a timer means (30) for judging whether the electrode advancing operation signal is transmitted at a timing within a predetermined time period or after elapse of the predetermined time period. Normal electrode advancing operation is performed when it is judged to be transmitted within the predetermined time period, the electrode advancing operation signal is not transmitted when it is judged to be transmitted after the elapse of the predetermined time period. With this, it is possible to secure safety during repair operation after the elapse of the predetermined time period.

### TECHNICAL FIELD

The present invention relates to an operation controller of an electrode and a control method therefor in electric resistance welding.

### BACKGROUND ART

In the field of the electric resistance welding, there is provided a method of advancing/retracting an electrode in relation to an operating state of a part supply unit. In this method, the electrode is advanced at a time point before a supply rod of the part supply unit is completely restored. With this, the electrode is advanced after the supply rod is retracted to some extent so as to avoid interference of the electrode with respect to the supply rod. Simultaneously, the electrode is advanced during restoring operation of the supply rod so as to reduce welding cycle time.
Patent Document 1: JP 09-57458 A

### DISCLOSURE OF THE INVENTION

### Problem to be Solved by the Invention

Normally, when a distal end portion of the supply rod comes into contact with an operator's hand, a signal is transmitted in response to the detection of the contact so as to inhibit the advancement of the electrode. However, when foreign matters such as iron scraps bite into a sliding portion of the supply rod in the case where the supply rod has advanced, the supply rod in some cases enters a locked state with having advanced and is not restored. In such a case, the operator inserts his/her hand so as to restore the supply rod. Even during the restoring operation, it is important to prevent the electrode from advancing despite the intention of the operator. In Patent Document 1, no technical measure is provided for inhibiting the abrupt advancement of the electrode as described above.

The present invention has been made to solve the above-mentioned problem, and an object of the present invention is to provide an operation controller of an electrode and a control method therefor in electric resistance welding, with which judgment can be made as to whether an operating time period of the supply rod falls within a regular time period or extends into an abnormal time period exceeding the regular time period basically by a timer means, and which are capable of automatically inhibiting the advancement of the electrode when the operating time period of the supply rod becomes abnormally longer.

### Means for Solving the Problem

According to an aspect of the present invention, there is provided an operation controller of an electrode in electric resistance welding, by which a part supplied by an advancing/retracting supply rod to the electrode is subjected to electric resistance welding with respect to a steel plate part, the operation controller including:

a sensor means which transmits an electrode advancing operation signal during restoring operation or at a time of completion of the restoring operation of the supply rod;

a timer means for judging whether the electrode advancing operation signal is transmitted at a timing within a predetermined time period or after elapse of the predetermined time period,

in which normal electrode advancing operation is performed in response to the electrode advancing operation signal transmitted within the predetermined time period, the electrode advancing operation signal not being transmitted after the elapse of the predetermined time period.

### Effects of the Invention

There are provided the sensor means which transmits the electrode advancing operation signal during restoring operation or at the time of completion of the restoring operation of the supply rod and the timer means for judging whether the electrode advancing operation signal is transmitted at the timing within the predetermined time period or after elapse of the predetermined time period. Therefore, when an operating cycle time of the supply rod is within the predetermined regular time period, a normal electrode advancing operation signal is transmitted, with the result that welding is effected by regular advancement of the electrode.

However, when foreign matters such as iron scraps bite into the sliding portion of the supply rod and the supply rod enters a locked state with having advanced, the timer means judges that the predetermined time period has elapsed. Transmission of the electrode advancing operation signal is inhibited based on the fact that the predetermined time period has elapsed, with the supply rod being under the abnormal operation as described above. Thus, when the operator inserts his/her hand so as to perform restoring operation of the supply rod, the electrode advancing operation signal has already inhibited from being automatically transmitted. Thus, the electrode does not advance despite the intention of the operator. That is, the electrode as a movable member does not pass by the operator's hand, and hence there is no risk that the electrode comes into contact with the operator's hand so as to injure the same. In other words, even when the operator forcibly restores the supply rod by hand, the electrode advancing operation signal is set in advance so as not to be transmitted from the sensor means.

Alternatively, even when foreign matters bite into the sliding portion of the supply rod and the supply rod is stopped in the middle of advancement, or when air pressure of compressed air deliver line in a factory is lowered for some reasons or other and an operating speed of the driving air cylinder of the supply rod is decreased, the timer means judges the elapse of the predetermined time period. Thus, by the judging operation, the electrode advancing operation signal is set in advance so as not to be transmitted.

Further, even when the supply rod is driven by an electric motor of an advancing/retracting force outputting type, the sensor means and the timer means may be caused to function as described above, and hence it is possible to prevent abrupt advancement of the electrode. Further, examples of the various types of the supply rod include a type of passing through the screw hole of the nut so as to supply the nut to the electrode, a type of holding the projection bolt with a holding head so as to insert the same into a receiving hole of the electrode, and a type of holding the nut in the recessed portion of the distal end portion of the supply rod so as to supply the nut to the electrode. In this embodiment, the supply rod of any type properly functions with respect to the operation of the electrode, and hence can be widely used.

When the above-mentioned normal electrode advancing operation is performed, the electrode advancing operation signal from the sensor means is transmitted at the timing before the elapse of the predetermined time period set by the timer means.

When a welding apparatus is normally operated, the operating cycle time of the supply rod is completed in a predetermined time period. When the supply rod is driven, for example, by the air cylinder, the predetermined time period is set based on an advancing/retracting stroke length of the supply rod, a pressure receiving area of a piston of the air cylinder, a supply air pressure, and the like. Therefore, the timing at which the electrode advancing operation signal transmitted from the sensor means is constant. Thus, when the electrode advancing operation signal is set in advance, before the elapse of the predetermined time period set by the timer means, so as to be transmitted from the sensor means, the electrode advancing operation signal is transmitted at a regular timing so as to effect regular welding.

The timer means is capable of starting timekeeping simultaneously with driving and advancing of the supply rod or from a time point when the supply rod advances to reach the predetermined position.

As described above, the start of timekeeping of the timer means is synchronized with the operation of the supply rod. Thus, the sensor means is facilitated to function by being accurately related to passage by the predetermined position during the restoring operation or the timing of completion of the restoring operation of the supply rod. That is, it is possible to reliably prevent the transmission of the electrode advancing operation signal from the sensor means after the elapse of the predetermined time period kept by the timer means.

The sensor means is capable of detecting operation of the supply rod or operation of an advance/retract driving means of the supply rod and transmitting the electrode advancing operation signal.

As described above, the electrode advancing operation signal is transmitted in response to the detection of the movement of the supply rod itself or the movable member of an air cylinder for driving the supply rod, the movement of an electric motor of an advancing/retracting force outputting type, and the like. Thus, it is possible to transmit the electrode advancing operation signal in accurate response to the predetermined position during the restoring operation or the timing of completion of the restoring operation of the supply rod, and hence possible to accurately maintain the timing at which the electrode starts to advance. Simultaneously, it is possible to set the timing at which the electrode advancing operation signal is transmitted correspondingly to the time period kept by the timer means, and hence possible to accurately perform the judging function of the timer means.

According to another aspect of the present invention, there is provided an operation control method for an electrode in electric resistance welding, by which a part supplied by an advancing/retracting supply rod to the electrode is subjected to electric resistance welding with respect to a steel plate part, the operation control method including:

preparing a welding device including:
a sensor means which transmits an electrode advancing operation signal during restoring operation or at a time of completion of the restoring operation of the supply rod; and
a timer means for judging whether the electrode advancing operation signal is transmitted at a timing within a predetermined time period or after elapse of the predetermined time period; and

performing normal electrode advancing operation in response to the electrode advancing operation signal transmitted within the predetermined time period, the electrode advancing operation signal not being transmitted after the elapse of the predetermined time period.

Operations and effects of the method according to the invention are the same as those of the apparatus according to the invention as described above.

When the normal electrode advancing operation is performed, the electrode advancing operation signal from the sensor means is transmitted at a timing before the elapse of the predetermined time period set by the timer means.

Further, the timer means is capable of starting timekeeping simultaneously with driving and advancing of the supply rod or from a time point when the supply rod reaches a predetermined position after having advanced.

In addition, the sensor means is capable of detecting operation of the supply rod or operation of an advance/retract driving means of the supply rod and transmitting the electrode advancing operation signal.

Operations and effects of those three modes of the present invention as described immediately above are the same as those of the apparatus according to the invention as described above.

### BRIEF DESCRIPTION OF THE DRAWINGS

FIG. 1 is a system block diagram of an entire welding device.

FIG. 2A is a sectional view of a part of a sensor means.

FIG. 2B is a side view of a part of a sensor means.

FIG. 3 is a timing chart showing operations of parts.

FIG. 4A is a sectional view of a supply rod in another mode.

FIG. 4B is a side view of a projection bolt.

FIG. 5A is a sectional view of a supply rod in still another mode.

FIG. 5B is a sectional view of a supply rod in yet another mode.

### LIST OF REFERENCE NUMERALS

1 projection nut

2 movable electrode

3 fixed electrode

4 steel plate part

6 air cylinder

8 guide pin

10 supply rod

16 air cylinder

24 controller

25 air-switching valve

27 sensor means

28 transmission controller

29 starting switch

30 timer means

39 projection bolt

43 receiving hole

45 holding head

51 square motion

52 holding recessed portion

### BEST MODE FOR CARRYING OUT THE INVENTION

Description will now be made on the best modes for operating an operation controller of an electrode and for carrying out a control method therefor in electric resistance welding according to the present invention.

### First Embodiment

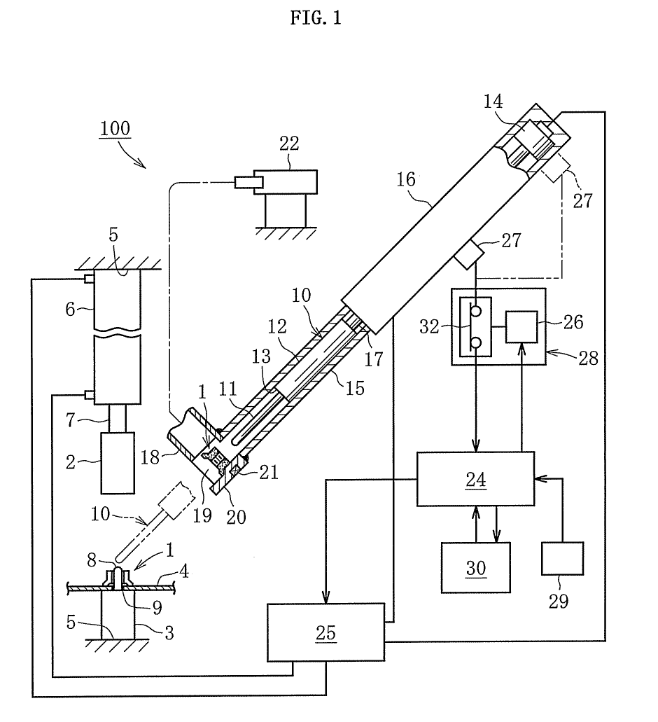

FIGS. 1 to 3 illustrate a first embodiment of the present invention. The first embodiment is an embodiment of an invention of the controller and an invention of the control method.

Description will be made on an entire welding device.

FIG. 1 is a system block diagram of the entire welding device. The entire welding device is denoted by reference numeral 100. A part in the first embodiment is a projection nut 1. The projection nut 1 is a normal quadrilateral one. That is, the projection nut is made of steel, provided with a screw hole formed at a central portion of a square body, and provided with welding projections at four corners on one side of the body having a quadrilateral shape. The quadrilateral shape corresponds to a square shape as seen from the axial direction of the screw hole. Dimensions of the portions are as follows: the square is 11 mm on each side; the screw hole is 5 mm in axial thickness; and the screw hole is 5 mm in inner diameter.

In the following description, the projection nut is sometimes simply referred to as nut.

Description will be made on electrode arrangement.

A movable electrode 2 and a fixed electrode 3 are arranged on an electrode axial line, and the nut 1 is subjected to electric resistance welding with respect to a steel plate part 4 placed on the fixed electrode 3. The movable electrode 2 is advanced/retracted by an air cylinder 6 fixed to a stationary member 5, the movable electrode 2 being joined to a piston rod 7 of the air cylinder 6. A guide pin 8 is provided at the central portion of the fixed electrode 3, and passes through a hole 9 of the steel plate part 4. The nut 1 is supplied to the fixed electrode 3, that is, the guide pin 8.

Description will now be made on a supply unit of the nut.

The nut 1 is supplied to the guide pin 8 by means of a supply rod 10. The supply rod 10 is constituted by a guide rod 11 passing through the screw hole of the nut 1, a slide rod 12 larger in diameter than the guide rod 11, and an extrusion surface 13 formed in the boundary portion between the guide rod 11 and the slide rod 12. The supply rod 10 is accommodated in a guide tube member 15 so that the slide rod 12 slidably advances/retracts in the guide tube member 15. An air cylinder 16 is joined to the guide tube member 15, and a piston rod 17 thereof is joined to the slide rod 12. The air cylinder 16 serves as an advance/retract driving means of the supply rod 10.

A supply tube 18 made of stainless steel is welded to the guide tube member 15, where a chamber 19 for temporary holding of a part is formed. A stopper piece 20 forming the inner surface of the chamber 19 is welded to the guide tube member 15 so as to catch the nut 1. In order to temporarily locking the nut 1, a permanent magnet 21 is embedded in the stopper piece 20. The supply tube 18 is connected to a parts feeder 22 by a supply hose made of synthetic resin. The nut 1 fed from the parts feeder 22 is sent into the chamber 19 via the supply tube 18 so as to be attracted to and held by the stopper piece 20 with an attractive force of the permanent magnet 21.

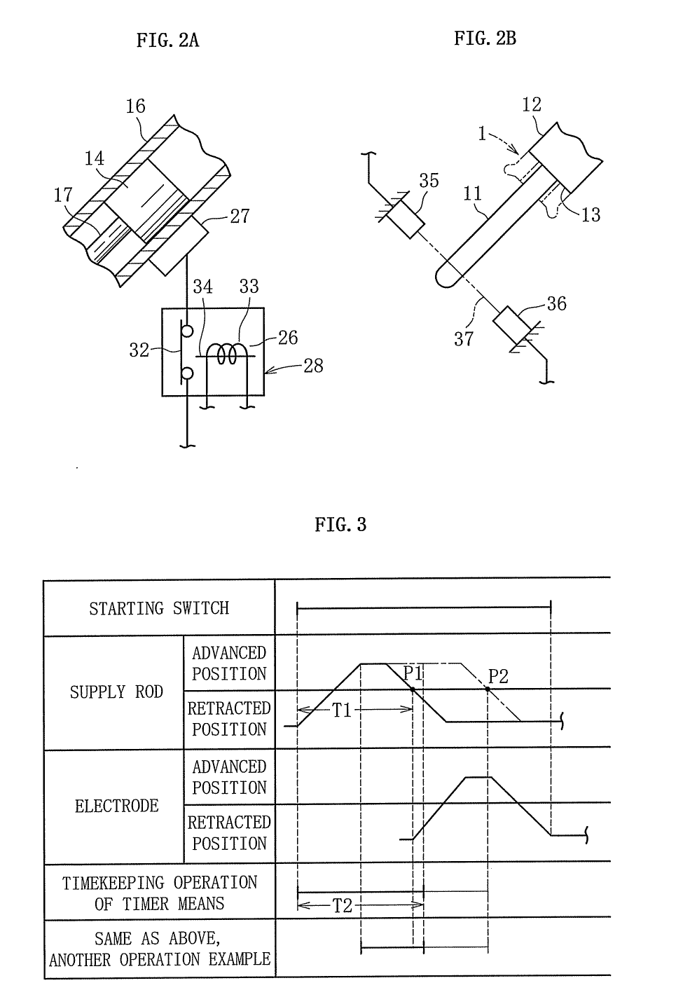

When the nut 1 is held by the stopper piece 20, the screw hole of the nut 1 and the guide rod 11 are coaxial with each other. In this case, when the operation of the air cylinder 16 causes the supply rod 10 to advance, the guide rod passes through the screw hole. After that, the extrusion surface 13 presses the top surface of the nut 1 so as to gradually extrude the nut 1 from the chamber 19. This state is illustrated by a chain double-dashed line in FIG. 2B. When the nut 1 is gradually extruded, the nut 1 is extruded while sliding on the stopper piece 20. Then, when the distal end portion of the guide rod 11 is stopped immediately before the guide pin 8, the nut 1 glides along the guide rod 11 so as to fit to the guide pin 8. The fitting is achieved after the guide pin 8 relatively passes through the screw hole.

After that, the operation of the air cylinder 6 causes the movable electrode 2 to advance, and the nut 1 is pressed against the steel plate part 4. Then, a welding current is applied thereto so as to perform welding. Note that, FIG. 1 illustrates a state in which the supply rod 10 is retracted most, and a piston 14 is positioned at the end portion of the air cylinder 16 at that time.

Next, description will be made on a control system.

In FIG. 1, arrow lines represent communication wires for delivering various signals. Other solid lines represent air-supply/discharge pipes connected between an air-switching valve and the air cylinders.

The controller 24 receives the various signals and sending operation signals to the air-switching valve 25, an actuator 26, and the like, the controller 24 being constituted by a sequencer or a computer device which are generally adopted. In order to transmit an electrode advancing operation signal during restoring operation of the supply rod 10, a sensor means 27 is attached on the outer surface of the air cylinder 16. Examples of the adoptable sensor means 27 include various one such as a capacitance type proximity sensor. In this case, there is used one adopting a type of magnetically detecting restoring passage of the piston 14 so as to transmit an electrode advancing operation signal. The sensor means 27 is arranged at a point of being operated in a time period when the supply rod 10 returns and departs from the advancement space of the movable electrode 2. Thus, the sensor means 27 is attached near the center of the air cylinder 16.

When the piston 14 passes by the point of the sensor means 27 during the restoring operation of the supply rod 10, an electrode advancing operation signal is transmitted on that timing. The signal is transmitted to the controller 24 through an intermediation of a transmission controller 28 which inhibits transmission of the electrode advancing operation signal. A pedal-operated starting switch is denoted by reference numeral 29, from which a starting signal is notified to the controller 24. Further, when the starting signal from the starting switch 29 is input to the controller 24, a timer means 30 starts timekeeping simultaneously with switching-on of the starting switch 29 based on the operation signal from the controller 24.

The air-switching valve 25 supplies/discharges operation air with respect to the air cylinder 16 and the air cylinder 6 in response to the operation signal from the controller 24. When the starting signal of the starting switch 29 is input to the controller 24, the operation signal based thereon is transmitted to the air-switching valve 25. In this manner, the operation air is fed from the air-switching valve 25 to the air cylinder 16, and the supply rod 10 advances in accordance with the advancement of the piston 14. Thus, the timer means 30 starts timekeeping simultaneously with the start of the advancement of the supply rod 10.

When the electrode advancing operation signal of the movable electrode 2, which is transmitted from the sensor means 27, is delivered to the controller 24, the operation signal is transmitted to the air-switching valve 25 based thereon, and the operation air is supplied/discharged from the air-switching valve 25 to the air cylinder 6. With this, the movable electrode 2 advances simultaneously with the transmission of the electrode advancing operation signal from the sensor means 27, and the nut 1 is welded to the steel plate part 4 under regular welding cycle time.

However, when foreign matters such as iron scraps bite into the sliding portion of the supply rod 10, the supply rod 10 is stopped at an advanced position in some cases as illustrated by chain double-dashed lines in FIG. 1. When the supply rod 10 remains stopped, a predetermined time period kept by the timer means 30 elapses. Thus, simultaneously with the elapse of time, a signal for inhibiting transmission of the electrode advancing operation signal is transmitted from the controller 24 to the transmission controller 28. The signal thus transmitted stops the transmission of the electrode advancing operation signal, and hence the movable electrode 2 does not advance even when an operator manually presses and returns the supply rod 10 after the elapse of a predetermined time period.

The transmission controller 28 functions such that the signal from the controller 24 prevents delivery of the electrode advancing operation signal from the sensor means 27 to the controller 24. Thus, it is sufficient for the transmission controller 28 to function as described above. In the first embodiment, the transmission controller 28 adopts a type of combining the actuator 26 with a normally-closed switch 32 so as to activate the actuator 26 for the purpose of forcibly opening the normally-closed switch 32. As illustrated in FIG. 2A, the actuator 26 is constituted by an exciting coil 33 and an operating iron-core 34 incorporated therein. When a signal notifying the elapse of a predetermined time period is transmitted from the controller 24, a starting current is applied to the exciting coil 33, and the normally-closed switch 32 is opened so that the electrode advancing operation signal is not transmitted.

Next, description will be made on operation timings.

The supply rod 10 illustrated in FIG. 1 strokes by 250 mm between a retracted position illustrated by solid lines and the advancement position illustrated by the chain double-dashed lines, and a time period T1 is set to 2 seconds, during which the supply rod 10 starts to advance so as to complete supply of the nut 1 and starts the restoring operation so that the piston 14 passes by the sensor means 27. Then, a predetermined time period T2 kept by the timer means 30 is set to 2.4 seconds. The 2 seconds is determined by the factors such as the 250-mm stroke of the supply rod 10 and the operating speed of the air cylinder 16, and hence the time period varies in accordance with changes in value of those factors. Further, the attachment position of the sensor means 27 is determined such that the electrode advancing operation signal is transmitted at a point where the supply rod 10 has returned by 100 mm from the position illustrated by the chain double-dashed lines of FIG. 1.

FIG. 3 is a timing chart showing a relation of the operation timings between the portions. When the starting switch 29 is switched-on, the supply rod 10 at the retraced position illustrated by the solid lines of FIG. 1 starts to advance, and simultaneously the timer means 30 starts timekeeping. The electrode advancing operation signal of the movable electrode 2 is transmitted from the sensor means 27 at a time point P1 at which the time period T1 has elapsed. Thus, the movable electrode 2 at the retracted position starts to advance in response to the signal, and welding is completed.

When the electrode advancing operation signal of the movable electrode 2 is transmitted from the sensor means 27, the distal end portion of the supply rod 10 is separated from the post-advancement operation space of the movable electrode 2. Therefore, the movable electrode 2 does not interfere with the supply rod 10. Further, the electrode advancing operation signal is transmitted in a state in which the supply rod 10 has not completely returned. Thus, a time period is reduced between the start of restoring of the supply rod 10 and the start of advancement of the movable electrode 2, which is effective for reduction of the welding cycle time and for an increase in productivity. In other words, the electrode advancing operation signal is transmitted at a time point when the supply rod 10 returns by 100 mm as described above, that is, at a position 150 mm short of a position at which the supply rod 10 is completely restored. Therefore, the welding cycle time is reduced.

Further, the movable electrode 2 starts to advance prior to the predetermined time period T2 kept by the timer means 30, that is, at 0.4 seconds prior to T2. Therefore, the signal for inhibiting transmission of the electrode advancing operation signal, which is transmitted after the elapse of the predetermined time period T2, is not transmitted to the transmission controller 28, and hence, regular welding operations are repeated.

When foreign matters such as iron scraps bite into the sliding portion of the supply rod 10 and the supply rod 10 is stopped at the advanced position as illustrated by the chain double-dashed lines in FIG. 1, the advanced state of the supply rod 10 continues as shown by chain lines in FIG. 3. When the predetermined time period T2 elapses during continuation of the advanced state, the normally-closed switch 32 of the transmission controller 28 is opened, with the result that the electrode advancing operation signal is not transmitted from the sensor means 27 to the controller 24.

Thus, even when an operator inserts his/her hand into the advanced supply rod 10 so as to perform repair operation, the electrode advancing operation signal is not automatically transmitted in this state. Thus, the movable electrode 2 does not abruptly advance. In other words, even when the supply rod 10 is pressed and returned by hand, the piston 14 passes by the sensor means 27 at the time point P2, and hence the electrode advancing operation signal is not transmitted.

Note that, a time period in which the predetermined time period T2 elapses after the supply rod 10 stops in an advanced state ranges from 0.5 to 0.8 seconds in this case. Thus, the predetermined time period T2 has already elapsed by the time when the operator inserts his/her hand. As a result, the electrode advancing operation signal is not transmitted, and the movable electrode 2 is prevented from abruptly advancing.

As described above, the electrode advancing operation signal is transmitted in the middle of restoring of the supply rod 10. Alternatively, as illustrated by the chain double-dashed lines in FIG. 1, the electrode advancing operation signal may be transmitted at a position where the supply rod 10 has completely returned. Such modification is adopted when the supply rod 10 is to be sufficiently retracted in relation to the peripheral relevant members or when sufficient cycle time is secured.

As described above, the timer means 30 starts timekeeping simultaneously with driving and advancing of the supply rod 10. Alternatively, as shown in the row of “SAME AS ABOVE, ANOTHER OPERATION EXAMPLE” in FIG. 3, the timekeeping may be started from a time point when the supply rod 10 reaches a predetermined position after having advanced. In this case, as shown in the chart, the timekeeping is started from the time point when the supply rod 10 reaches the advanced position.

The electrode advancing operation signal is transmitted from the sensor means 27 attached to the air cylinder 16 during restoring operation or at the time of completion of the restoring operation of the supply rod 10. Alternatively, as illustrated in FIG. 2B, the electrode advancing operation signal may be transmitted by detecting restoring movement of the supply rod 10 itself. The electrode advancing operation signal is transmitted at a time point when the supply rod 10 departs from a sensing line 37 of a photo-interrupter constituted by a light-emitting element 35 and a light-receiving element 36.

In the above-mentioned embodiment, the piston 14 passes by the sensor means 27 when the supply rod 10 advances. However, in order not to transmit the electrode advancing operation signal at the time of advancing, it is sufficient that a normal canceling circuit (not shown) is adopted. Further, while the air cylinders of various types are adopted, an electric motor which outputs advancing/retracting force may be adopted in place thereof. When the supply rod 10 is driven by the electric motor, the electrode advancing operation signal is transmitted from the sensor means 27 in response to the movement of an advancing/retracting member of the electric motor.

Operations and effects of the first embodiment are as follows.

There are provided the sensor means 27 which transmits the advancing operation signal of the movable electrode 2 during the restoring operation or at the time of completion of the restoring operation of the supply rod 10, and the timer means 30 for judging whether the advancing operation signal of the movable electrode 2 is transmitted at a timing within the predetermined time period T2 or after elapse of the predetermined time period T2. Thus, when an operating cycle time of the supply rod 10 is regularly completed within a predetermined time period, a normal electrode advancing operation signal is transmitted, with the result that welding is effected by regular advancement of the movable electrode 2.

However, when foreign matters such as iron scraps bite into the sliding portion of the supply rod 10 and the supply rod 10 enters a locked state, the timer means 30 judges that the predetermined time period T2 has elapsed. An inhibiting signal is transmitted based on the fact that the predetermined time period T2 has elapsed, with the supply rod 10 having advanced as described above. As a result, the actuator 26 is activated and open the normally-closed switch 32 so as to inhibit the transmission of the advancing operation signal of the movable electrode 2. Thus, when the operator inserts his/her hand so as to perform restoring operation, the advancing operation signal of the movable electrode 2 has already inhibited from being automatically transmitted. Thus, the movable electrode 2 does not advance despite the intention of the operator. That is, the movable electrode 2 as a movable member does not pass by the operator's hand, and hence there is no risk that the movable electrode 2 comes into contact with the operator's hand so as to injure the same. In other words, even when the operator forcibly restores the supply rod 10 by hand, the advancing operation signal of the movable electrode 2 is set in advance so as not to be transmitted from the sensor means 27.

Alternatively, even when foreign matters bite into the sliding portion of the supply rod 10 and the supply rod 10 is stopped in the middle of advancement, or when air pressure in a factory is lowered for some reasons or other and an operating speed of the driving air cylinder 16 of the supply rod 10 is decreased, the timer means 30 judges the elapse of the predetermined time period T2. Thus, by the judging operation, the advancing operation signal of the movable electrode 2 is set in advance so as not to be transmitted.

Further, even when the supply rod 10 is driven by an electric motor of an advancing/retracting force outputting type, the sensor means 27 and the timer means 30 may be caused to function as described above, and hence it is possible to prevent abrupt advancement of the electrode. Further, examples of the various types of the supply rod 10 include a type of passing through the screw hole of the nut 1 so as to supply the nut 1 to the electrode, a type of holding the projection bolt with a holding head so as to insert the same into a receiving hole of the electrode, and a type of holding the nut 1 in the recessed portion of the distal end portion of the supply rod 10 so as to supply the nut 1 to the electrode. In this embodiment, the supply rod 10 of any type properly functions with respect to the operation of the movable electrode 2, and hence can be widely used.

When the above-mentioned normal electrode advancing operation is performed, the electrode advancing operation signal from the sensor means 27 is transmitted at the timing P1 before the elapse of the predetermined time period T2 set by the timer means 30.

When a welding apparatus 100 is normally operated, the operating cycle time of the supply rod 10 is completed in a predetermined time period. When the supply rod 10 is driven by the air cylinder 16, the predetermined time period is based on a 250-mm advancing stroke length of the supply rod 10, a pressure receiving area of the piston of the air cylinder 16, a supply air pressure, and the like. Therefore, the timing P1 at which the advancing operation signal of the movable electrode 2, which is transmitted from the sensor means 27, is constant. Thus, when the electrode advancing operation signal of the movable electrode 2 is set in advance, before the elapse of the predetermined time period T2 set by the timer means 30, so as to be transmitted from the sensor means 27, the electrode advancing operation signal is transmitted at a regular timing so as to effect regular welding.

The timer means 30 starts timekeeping simultaneously with driving and advancing of the supply rod 10 or from a time point when the supply rod 10 reaches the advanced position.

As described above, the start of timekeeping of the timer means 30 is synchronized with the operation of the supply rod 10. Thus, the sensor means 27 is facilitated to function by being accurately related to passage by the predetermined position during the restoring operation or the timing of completion of the restoring operation of the supply rod 10. That is, it is possible to reliably prevent the transmission of the electrode advancing operation signal of the movable electrode 2 from the sensor means 27 after the elapse of the predetermined time period T2 kept by the timer means 30.

The sensor means 27 transmits the electrode advancing operation signal in response to the detection of the operation of the supply rod 10 itself or the detection of the piston movement of the air cylinder 16 for driving the supply rod 10.

As described above, the electrode advancing operation signal of the movable electrode 2 is transmitted in response to the detection of the retraction of the supply rod 10 itself with the light-emitting element 35 and the light-receiving element 36 or the detection of the movement of the piston 14 of the air cylinder 16. Thus, it is possible to transmit the electrode advancing operation signal of the movable electrode 2 in accurate response to the predetermined position during the restoring operation or the timing of completion of the restoring operation of the supply rod 10, and hence possible to accurately maintain the timing P1 at which the movable electrode 2 starts to advance. Simultaneously, it is possible to set the timing P1 at which the electrode advancing operation signal is transmitted correspondingly to the time period T2 kept by the timer means 30, and hence possible to accurately perform the judging function of the timer means 30.

Operations and effects of the control method according to the first embodiment are the same as those of the controller according to the first embodiment as described above.

### Second Embodiment

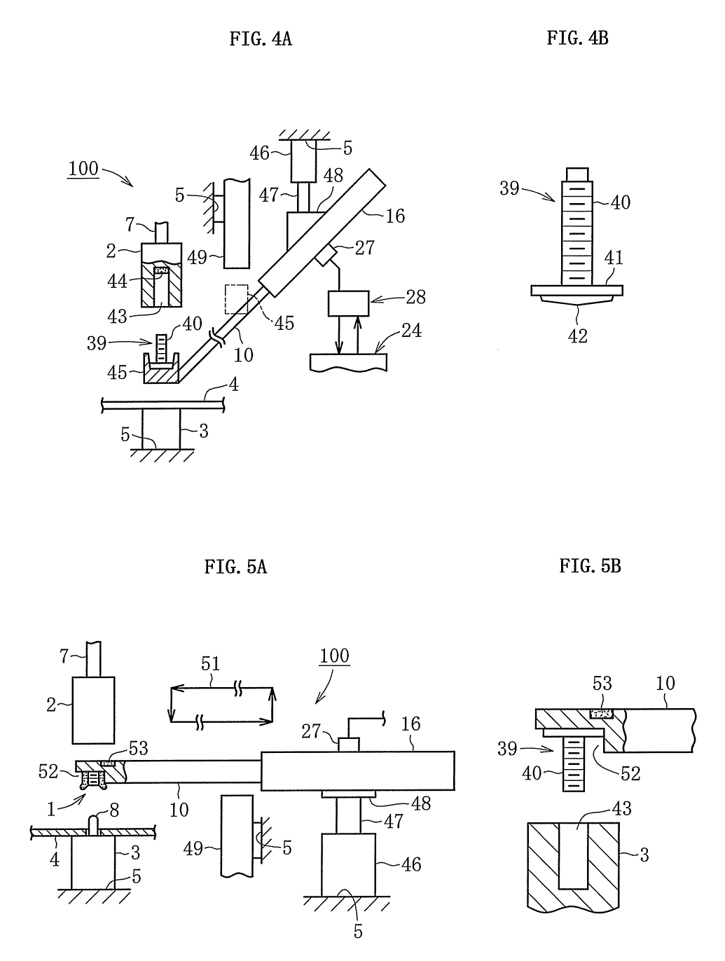

FIG. 4A illustrates a second embodiment of the present invention.

In the second embodiment, the nut 1 in the first embodiment described above is replaced with a steel projection bolt. As illustrated in FIG. 4B, a projection bolt 39 is constituted by a shaft portion 40 provided with a male thread, a disk-shaped flange portion 41 formed concentrically with the shaft portion 40, and a disk-shaped welding projection 42 concentric with the shaft portion 40, which is formed on the flange surface opposed to the shaft portion 40. Note that, in the following description, the projection bolt is sometimes simply referred to as bolt.

At a central portion of the movable electrode 2, a receiving hole 43 is provided in the same direction as that of the advancing/retracting directions of the movable electrode 2, and a permanent magnet 44 is attached on the innermost side thereof. A cup-shaped holding head 45 is attached at the distal end portion of the supply rod 10, and the bolt 39 is held by being accommodated therein. An air cylinder 46 is fixed to the stationary member 5, and the lower end of a piston rod 47 thereof is joined to a bracket 48 fixed to the air cylinder 16. Further, the advancing/retracting directions of the piston rod 47 is the same as the advancing/retracting directions of the movable electrode 2. A supply tube 49 is fixed to the stationary member 5, and the bolt 39 fed from a parts feeder (not shown) is supplied to the holding head 45 via the supply tube 49. The other structure including non-illustrated portions is the same as that of the first embodiment described above, and the members having the same functions are denoted by the same reference numerals.

When the supply rod 10 is stopped at the retracted position, the bolt 39 is supplied to the holding head 45. Then, the supply rod 10 advances and stops at a position where the shaft portion 40 of the bolt 39 is coaxial with the receiving hole 43. Next, when the air cylinder 16 and the supply rod 10 rise in accordance with the operation of the air cylinder 46, the shaft portion 40 is inserted into the receiving hole 43 and attracted by the permanent magnet 44. After that, the air cylinders 46 and 16 perform reverse operations so as to be restored to the original positions. The movable electrode 2 holding the bolt 39 advances and the welding projection 42 is pressed against the steel plate part 4 before completion of welding. Other operations and effects are the same as those of the first embodiment.

### Third Embodiment

FIG. 5A illustrates a third embodiment of the present invention.

As illustrated in FIG. 5A, in the third embodiment, the operation of the supply rod 10 corresponds to a square motion denoted by the reference numeral 51, and the nut 1 is supplied thereby. In order to perform the square motion, advancing/retracting force outputting directions of the air cylinder 16 and the air cylinder 46 are perpendicular to each other. Further, the holding recessed portion 52 having a cut-out shape is formed at the distal end portion of the supply rod 10, and a permanent magnet 53 is attached in the vicinity thereof.

Further, FIG. 5B illustrates a case of supplying the bolt 39. The other structure including non-illustrated portions is the same as that of the embodiments described above, and the members having the same functions are denoted by the same reference numerals.

When the supply rod 10 is stopped at the retracted position, the nut 1 or the bolt 39 is supplied to the holding recessed portion 52. Then, the supply rod 10 advances and stops at a position where the nut 1 or the bolt 39 is coaxial with the guide pin 8 or the receiving hole 43. Next, when the air cylinder 16 and the supply rod 10 lower in accordance with the operation of the air cylinder 46, the nut 1 or the bolt 39 is supplied to the electrode. After that, the air cylinders 46 and 16 perform reverse operations so as to be restored to the original positions. Other operations and effects are the same as those in the embodiments described above.

### INDUSTRIAL APPLICABILITY

As described above, the operation controller of an electrode and the control method therefor in electric resistance welding according to the present invention are provided for automatically inhibiting, when the operating time period of the supply rod becomes abnormally longer, the advancement of the electrode. Thus, when failures occur during the restoring operation of the supply rod, it is possible to automatically stop the advancement of the electrode. Therefore, the operation controller of an electrode and the control method therefor in electric resistance welding according to the present invention can be used in the various industrial fields such as a vehicle-body welding step or a sheet-metal welding step of a home appliance.

1. An operation controller of an electrode in electric resistance welding, by which a part supplied by an advancing/retracting supply rod to the electrode is subjected to electric resistance welding with respect to a steel plate part, the operation controller comprising:
a sensor means which transmits an electrode advancing operation signal during restoring operation or at a time of completion of the restoring operation of the supply rod;
a timer means for judging whether the electrode advancing operation signal is transmitted at a timing within a predetermined time period or after elapse of the predetermined time period,
wherein normal electrode advancing operation is performed in response to the electrode advancing operation signal transmitted within the predetermined time period, the electrode advancing operation signal not being transmitted after the elapse of the predetermined time period.

2. An operation controller of an electrode in electric resistance welding according to claim 1, wherein, when the normal electrode advancing operation is performed, the electrode advancing operation signal from the sensor means is transmitted at a timing before the elapse of the predetermined time period set by the timer means.

3. An operation controller of an electrode in electric resistance welding according to claim 1, wherein the timer means starts timekeeping simultaneously with driving and advancing of the supply rod or from a time point when the supply rod advances to reach a predetermined position.

4. An operation controller of an electrode in electric resistance welding according to claim 1, wherein the sensor means detects operation of the supply rod or operation of an advance/retract driving means of the supply rod and transmits the electrode advancing operation signal.

5. An operation control method for an electrode in electric resistance welding, by which a part supplied by an advancing/retracting supply rod to the electrode is subjected to electric resistance welding with respect to a steel plate part, the operation control method comprising:
preparing a welding device comprising:
a sensor means which transmits an electrode advancing operation signal during restoring operation or at a time of completion of the restoring operation of the supply rod; and
a timer means for judging whether the electrode advancing operation signal is transmitted at a timing within a predetermined time period or after elapse of the predetermined time period; and
performing normal electrode advancing operation in response to the electrode advancing operation signal transmitted within the predetermined time period, the electrode advancing operation signal not being transmitted after the elapse of the predetermined time period.

6. An operation control method for an electrode in electric resistance welding according to claim 5, wherein, when the normal electrode advancing operation is performed, the electrode advancing operation signal from the sensor means is transmitted at a timing before the elapse of the predetermined time period set by the timer means.

7. An operation control method for an electrode in electric resistance welding according to claim 5, wherein the timer means starts timekeeping simultaneously with driving and advancing of the supply rod or from a time point when the supply rod reaches a predetermined position after having advanced.

8. An operation control method for an electrode in electric resistance welding according to claim 5, wherein the sensor means detects operation of the supply rod or operation of an advance/retract driving means of the supply rod and transmits the electrode advancing operation signal.

9. An operation controller of an electrode in electric resistance welding according to claim 2, wherein the timer means starts timekeeping simultaneously with driving and advancing of the supply rod or from a time point when the supply rod advances to reach a predetermined position.

10. An operation controller of an electrode in electric resistance welding according to claim 2, wherein the sensor means detects operation of the supply rod or operation of an advance/retract driving means of the supply rod and transmits the electrode advancing operation signal.

11. An operation controller of an electrode in electric resistance welding according to claim 3, wherein the sensor means detects operation of the supply rod or operation of an advance/retract driving means of the supply rod and transmits the electrode advancing operation signal.

12. An operation controller of an electrode in electric resistance welding according to claim 9, wherein the sensor means detects operation of the supply rod or operation of an advance/retract driving means of the supply rod and transmits the electrode advancing operation signal.

13. An operation control method for an electrode in electric resistance welding according to claim 6, wherein the timer means starts timekeeping simultaneously with driving and advancing of the supply rod or from a time point when the supply rod reaches a predetermined position after having advanced.

14. An operation control method for an electrode in electric resistance welding according to claim 6, wherein the sensor means detects operation of the supply rod or operation of an advance/retract driving means of the supply rod and transmits the electrode advancing operation signal.

15. An operation control method for an electrode in electric resistance welding according to claim 7, wherein the sensor means detects operation of the supply rod or operation of an advance/retract driving means of the supply rod and transmits the electrode advancing operation signal.

16. An operation control method for an electrode in electric resistance welding according to claim 13, wherein the sensor means detects operation of the supply rod or operation of an advance/retract driving means of the supply rod and transmits the electrode advancing operation signal.
